(19) United States
(12) Patent Application Publication
(10) Pub. No.: US 2006/0087756 A1
(43) Pub. Date: Apr. 27, 2006

(54) Color wheel

(76) Inventors: Ching-Hsiang Yu, Taoyuan Hsien (TW); Chia-Chi Wu, Taoyuan Hsien (TW)

Correspondence Address: BIRCH STEWART KOLASCH & BIRCH, PO BOX 747, FALLS CHURCH, VA, 22040-0747, US

(21) Appl. No.: 11/256,089

(22) Filed: Oct. 24, 2005

(30) Foreign Application Priority Data
Oct. 26, 2004 (TW) 93132456

(51) Int. Cl. G02B 7/00

(52) U.S. Cl. 359/892; 359/889

(57) ABSTRACT

A color wheel. The color wheel includes a plurality of filters, at least one driving device and at least one binder. The filters are disposed around the driving device and arrayed in a predetermined shape, without glue provided therebetween. The binder encircles and maintains the filters in positions.

### BACKGROUND

The invention relates to a color wheel, and in particular, to a color wheel capable of preventing separation of filters therefrom.

Conventionally, in a projection apparatus (e.g. projector or projection television), a color wheel is provided for coloring the light projected from a light source to a display panel. The color wheel comprises a plurality of filters which may be different from each other. Different types of filters generate light beams of different colors. When the color wheel is rapidly rotated, the images on the display panel are colored.

Referring to FIG. 1, structurally, a color wheel 100 comprises a plurality of sectorial filters 102, a connecting structure 104 and a motor 106. The filters 102 are glued to the outer edges of the connecting structure 104, and the connecting structure 104 is fixed to the motor 106. By this arrangement, the motor 106 is capable of rotating the filters 102.

A projection apparatus with a larger projection area and higher color saturation than the conventional is desirable, hence, the outer radius of the filters and the speed of the motor are increased. As a result, centrifugal forces exerted on the filters during high-speed rotation increase, potentially causing separation of the filters from the color wheel.

Furthermore, to increase lumen output, projection apparatuses are provided with higher power light sources. Increased power consumption, however, inherently generates excessive heat which may cause thermal deformation of the filters and ageing of the glue used in the color wheel. This may also causes separation of the filters from the color wheel during rotation after long-term use.

Thus, a color wheel capable of meeting the requirements and developments of modern projection apparatuses with short response time and high color saturation is desirable.

### SUMMARY

To solve the above problems, the invention provides a color wheel capable of preventing separation of filters therefrom after long-term use.

The invention also provides a color wheel capable of preventing separation of filters therefrom due to thermal deformation of the filters.

The invention further provides a color wheel suitable for a projection apparatus with short response time and high color saturation.

A color wheel in accordance with an exemplary embodiment of the invention includes a plurality of filters, at least one driving device and at least one annular binder. The filters are disposed around the driving device and arrayed in a predetermined shape. The annular binder encircles and maintains the positions of the filters.

A color wheel in accordance with another exemplary embodiment of the invention includes at least one filter, at least one driving device and at least one annular binder. The driving device is connected to the filter in a coaxial manner. The annular binder encircles the filter.

A color wheel in accordance with another exemplary embodiment of the invention includes a plurality of filters and at least one annular binder. The filters are arrayed in a predetermined shape. The annular binder encircles and maintains the filters in positions.

In the color wheel, the filters may be maintained in positions merely by the annular binder. There is no need to connect the filters via glue.

The invention also provides a projection apparatus including the described color wheel.

The filters and the binder are assembled together by an engaged, wedged, glued, or tightly fitted manner. The inner surfaces of the annular binder preferably match the outer edges of the filters. The inner surfaces may be a curve shape, L-shape, U-shape, a shape with at least two faces, or matched with an outer edges of the filters. The annular binder includes at least two holding structures. The at least two holding structures are disposed at outer edges of the filters and hold the filters in opposite directions, respectively. The two holding structures may be mirroring structures. It is noted that the filters are maintained in positions merely by the annular binder. No glue is provided to connect the filters.

The binder may be constructed by a plurality of portions fixed to each other, or an integrally formed annular ring. The color wheel may further include a connecting structure, around which the filters are disposed.

Moreover, the. color wheel may include a layer of glue disposed between the annular binder and the filters. All the colors of light filtered by the filters are not the same. The driving device may be a motor. The color wheel may further include a connecting structure between the motor and the filters. The predetermined shape may be annular, circular or polygonal.

In the invention, the annular binder maintains the positions of the filters, thereby preventing separation of the filters from the color wheel even after long-time use at high rotational speed.

The annular binder is further capable of preventing thermal deformation of the filters when the environmental temperature is high. Therefore, separation of the filters from the color wheel caused by thermal deformation can be effectively avoided.

Furthermore, the annular binder is disposed at the outer edges of the filters. Therefore, the filters are firmly connected even if the outer radius of the filters is great. From the previous description, it is understood that the color wheel of the invention is suitable for a projection apparatus with short response time and high color saturation.

### BRIEF DESCRIPTION OF THE DRAWINGS

The invention can be more fully understood by reading the subsequent detailed description and examples with references made to the accompanying drawings, wherein:

FIG. 1 is an exploded perspective view of a conventional color wheel;

FIG. 2 is an exploded perspective view of a color wheel in accordance with an embodiment of the invention; and

FIGS. 3A-3E depict the connection of the filters to the annular binder of the invention in various manners.

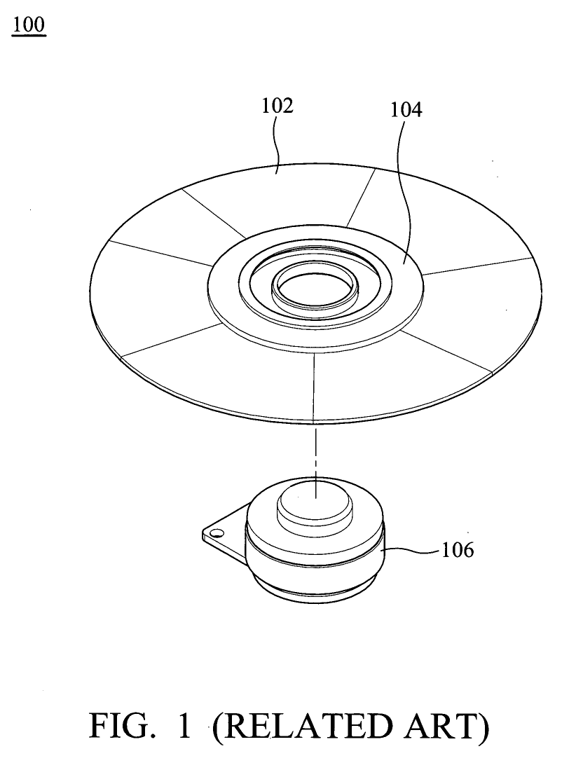

### DETAILED DESCRIPTION

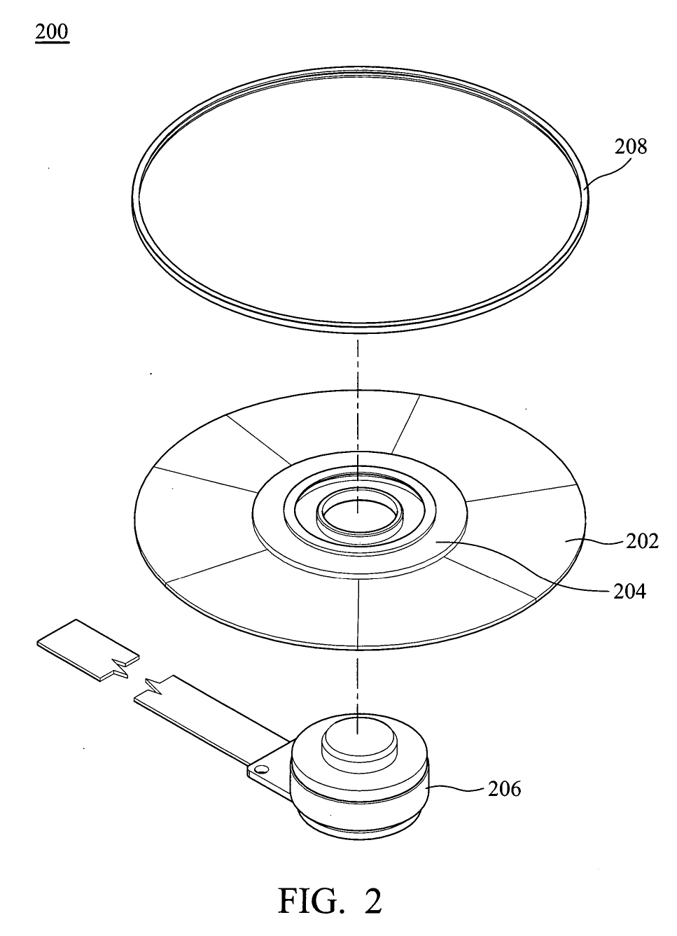

FIG. 2 depicts a color wheel in accordance with an embodiment of the invention, wherein the color wheel 200, used as a color-selecting structure, comprises at least one filter 202 and a single annular binder 208.

The filter 202 is used for filtering the light beams passing therethrough, thereby coloring the light beams. The color wheel 200 may comprise a plurality of filters or a single filter 202. Furthermore, the filters may be the same or different. Preferably, the color wheel 200 comprises different filters 202 for generating light beams with different colors. The filter/filters 202 may be sectorial or annular.

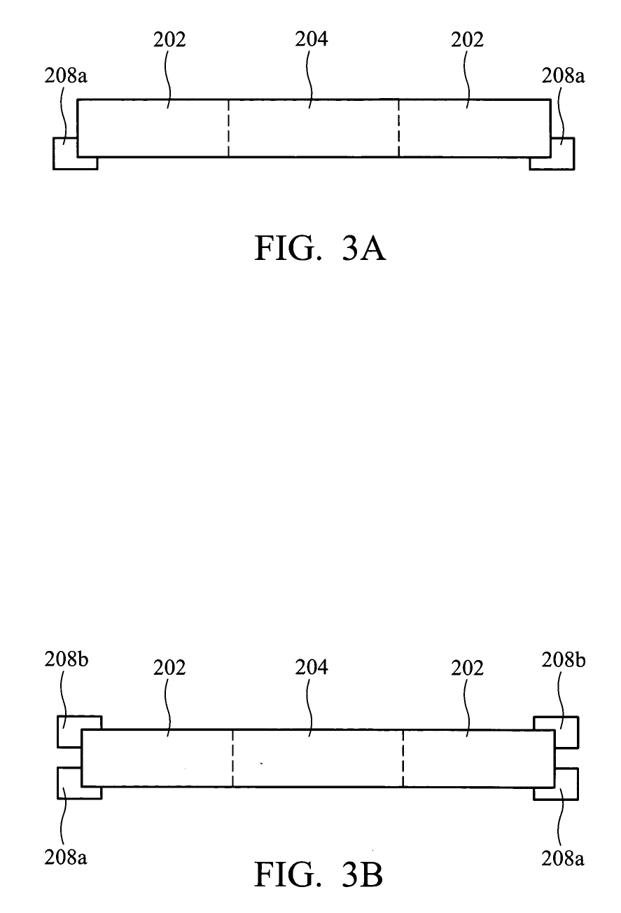

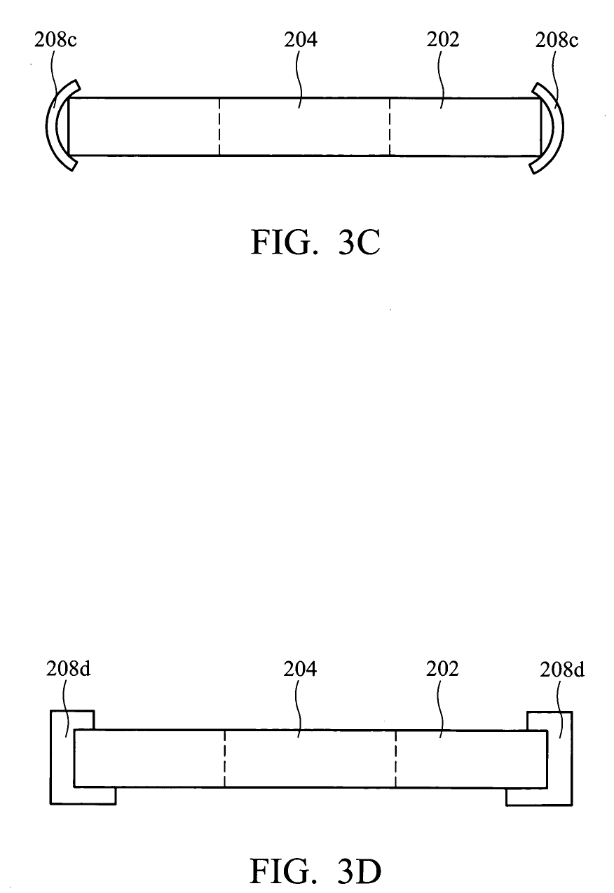

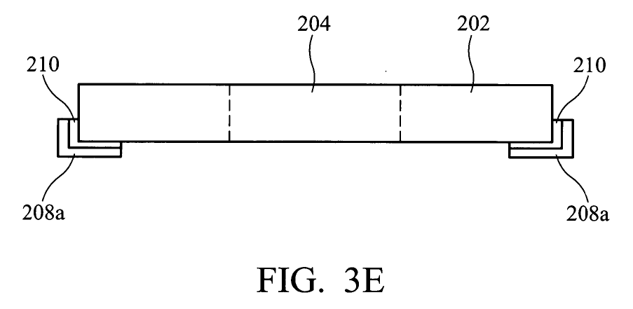

The annular binder 208 is disposed at outer edges of the filters 202, maintaining the arrayed filters 202 in a particular shape. The particular shape is, for example, annular, circular or polygonal. The filters 202 and the binder 208 are assembled together by an engaged, wedged, glued, or tightly fitted manner. FIG. 3A depicts the outer edges of the filters 202 tightly fitted to the single annular binder 208. FIG. 3B depicts the outer edges held by annular binder 208a and 208b in opposite directions, wherein no glue is provided to connect the filters 202. Furthermore, the binder 208a and 208b also can be mirroring structures, wherein the glue or no glue is provided to connect the filters 202. FIG. 3C depicts the outer edges abutting against the annular binder 208c. FIG. 3D depicts the outer edges wedged into the annular binder 208d. FIG. 3E depicts the outer edges tightly fitted and glued to the annular binder 208a via a layer of glue 210.

To ensure the connection of the filters 202 to the annular binder 208, the inner surface of the annular binder 208 may be a curve shape, L-shape, U-shape, a shape with at least two faces, or matched with outer edges of the filters. Furthermore, the binder 208 may be constructed by a plurality of portions fixed to each other, or an integrally formed annular ring.

The color wheel 200 may further comprise a driving device, around which the filters 202 are disposed. In particular, the driving device and the filters are coaxially arranged. The driving device is, for example, a motor 206. In FIG. 2, the motor 206 is a spindle motor. By this arrangement, the motor 206 is capable of rotating the filters 202.

The color wheel 200 may further comprise a connecting structure 204, around which the filters 202 are disposed. The filters 202 are firmly held by the connecting structure 204 at their inner edges and the annular binder 208 at their outer edges. The connecting structure 204 connects the filters 202 and the motor 206, to effectively reduce the shock caused by rotation of the motor 206.

In the invention, the annular binder maintains the filters in their positions, thereby preventing separation of the filters from the color wheel even after long-term use at high rotational speed.

The annular binder is further capable of preventing thermal deformation of the filters when the environmental temperature is high. Thus, separation of the filters from the color wheel caused by thermal deformation can be effectively avoided.

Furthermore, the annular binder is disposed at the outer edges of the filters. Therefore, the filters are firmly connected even if the outer radius of the filters is great. From the previous descriptions, it is understood that the color wheel of the invention is suitable for a projection apparatus with short response time and high color saturation.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A color wheel comprising:
at least one driving device;
a plurality of filters disposed around the driving device and arrayed in a predetermined shape, without glue provided therebetween; and
at least one binder encircling and maintaining positions of the filters.

2. The color wheel as claimed in claim 1, wherein the filters and the binder are assembled together by an engaged, wedged, glued, or tightly fitted manner.

3. The color wheel as claimed in claim 1, wherein an inner surface of the binder has a curve shape, L-shape, U-shape, a shape with at least two faces, or matched with an outer edges of the filters.

4. The color wheel as claimed in claim 1, wherein the binder comprises at least two holding structures, and the two holding structures are mirroring structures.

5. The color wheel as claimed in claim 4, wherein the at least two holding structures are disposed at outer edges of the filters and hold the filters in opposite directions, respectively.

6. The color wheel as claimed in claim 1, wherein the binder is constructed by a plurality of portions fixed to each other, or an integrally formed annular ring.

7. The color wheel as claimed in claim 1, further comprising a glued layer disposed between the binder and the filters.

8. The color wheel as claimed in claim 1, wherein the filters are sectorial or annular.

9. The color wheel as claimed in claim 1, further comprising a connecting structure disposed between the filters and the driving device.

10. The color wheel as claimed in claim 1, wherein the predetermined shape is annular, circular, or polygonal.

11. The color wheel as claimed in claim 1, wherein the driving device and the filters are coaxial.

12. A color wheel comprising:
a driving device;
at least one filter driven by the driving device; and
a single binder encircling and maintaining a position of the filter.

13. The color wheel as claimed in claim 12, wherein the filter and the binder are assembled together by an engaged, wedged, glued, or tightly fitted manner.

14. The color wheel as claimed in claim 12, wherein inner surface of the binder has a curve shape, L-shape, U-shape, a shape with at least two faces, or matched with an outer edge of the filter.

15. The color wheel as claimed in claim 12, further comprising a glued layer disposed between the binder and the filter.

16. The color wheel as claimed in claim 12, wherein the filter is sectorial or annular.

17. The color wheel as claimed in claim 12, further comprising a connecting structure disposed between the filter and the driving device.

18. A color wheel comprising:
at least one filter; and
a single binder encircling and maintaining a position of the filter.

19. The color wheel as claimed in claim 18, wherein the filter and the binder are assembled together by an engaged, wedged, glued, or tightly fitted manner.

20. The color wheel as claimed in claim 18, wherein inner surface of the binder has a curve shape, L-shape, U-shape, a shape with at least two faces, or matched with an outer edge of the filter.
